(19) United States
(12) Patent Application Publication
(10) Pub. No.: US 2021/0222728 A1
(43) Pub. Date: Jul. 22, 2021

(54) STEERING ASSEMBLY COMPRISING A SEALING ELEMENT IMPROVING A SEAL OF A STEERING BALL JOINT

(71) Applicant: JTEKT EUROPE, Irigny (FR)

(72) Inventor: Philippe DURAND, Villeurbanne (FR)

(73) Assignee: JTEKT EUROPE, Irigny (FR)

(21) Appl. No.: 17/059,494

(22) PCT Filed: May 23, 2019
(86) PCT No.: PCT/FR2019/051185

§ 371 Date: Nov. 30, 2020

(30) Foreign Application Priority Data
May 28, 2018 (FR) 18/54494

(51) Int. Cl. F16C 11/06; F16J 3/04

(52) U.S. Cl. CPC F16C 11/0671; F16J 3/042; F16C 2326/24; F16C 2326/05; F16C 11/0695

(57) ABSTRACT

A steering assembly of a vehicle, including a connecting rod, one end of which includes a steering ball joint, a hub element of a wheel of the vehicle, and a sealing bellows which is positioned between the steering ball joint and the hub element, wherein the steering assembly further includes at least one sealing element which has an insulation face in contact with the hub element and a sliding face in contact with the sealing bellows.

The invention concerns the field of power steering devices and more particularly a steering assembly of a vehicle, as well as a method for mounting said assembly.

The object of a vehicle steering system is to allow a driver to control a vehicle trajectory by exerting a force on a steering wheel.

Generally, a steering system comprises a steering wheel, a steering column, and a rack provided with two ends, each connected to a tie-rod.

The tie-rod is provided at one end with a steering ball joint comprising a rotation casing in which a pivot is inserted. The pivot comprises a generally spherical shaped head intended to be positioned in the rotation casing, and a body intended to be inserted into an orifice of a hub element of a vehicle wheel. A hub element, also called a knuckle carrier or hub carrier, is a mechanical part which supports a mechanical bearing, and therefore indirectly a hub, of the wheel.

The tie-rod thus allows a modification of the orientation of the wheel by a relative movement of the rotation casing relative to the hub element.

Furthermore, in order to limit failures of the steering ball joint, such as a clearance or a noise, related to an introduction of dust and humidity between the rotation casing and the head of the pivot, it is known to positioning a bellows seal between the rotation casing and a contact surface of the hub element. The bellows seal is generally made of an elastomeric material allowing elastic deformation.

In some manufacturers, the hub element is made of a corrodable material, such as cast iron, which is covered with a protective layer in order to prevent damage from corrosion.

In order to obtain a sufficiently smooth surface condition to allow a seal with the bellows seal, the contact surface is machined, that is to say the protective layer is removed. Thus, during the use of the vehicle, the condition of the contact surface of the hub element will corrode over time. There is thus a wear of the bellows seal, the latter no longer making it possible to ensure a satisfactory seal between the hub element and the rotation casing, which reduces the life of the steering ball joint.

The object of the invention is to improve the life of the steering ball joint by improving the seal provided between the hub element and the bellows seal.

The invention provides for this purpose a steering assembly of a vehicle comprising a tie-rod, whose one end comprises a steering ball joint, a hub element of a vehicle wheel, and a bellows seal positioned between the steering ball joint and the hub element, characterized in that the steering assembly further comprises at least one sealing element having an insulating face in contact with the hub element and a sliding face in contact with the bellows seal.

The sealing element is positioned between the bellows seal and the hub element such that the bellows seal does not contact the hub element.

The sealing element is fixed with respect to the hub element, that is to say there is no relative movement of one with respect to the other, so as to create a seal between the hub element and the sealing element. More precisely, the sealing element ensures by the insulating face a static seal with the hub element, that is to say that the seal is achieved by a slight deformation of the insulating face on the hub element.

Furthermore, an orientation of the vehicle wheel causes relative movement of the steering ball joint, and therefore of the bellows seal, with respect to the hub element. The bellows seal is therefore movable relative to the hub element.

The bellows seal exerts pressure on the sealing element, and more precisely on the sliding face, so as, on the one hand, to ensure a seal between the bellows seal and the sealing element, and on the other hand to be able to slide on the sliding face of the sealing element without degrading.

The seal element ensures a seal between the bellows seal and the hub element without the bellows seal coming into direct contact with the hub element. The bellows seal are thus not degraded by the hub element.

According to a characteristic of the invention, the sealing element comprises materials insensitive to corrosion.

Thus, the sealing element is not degraded over time by a corrosion phenomenon.

The non-corroding sliding face allows optimal sliding of the bellows seal throughout the life of the vehicle.

Furthermore, the sealing element, through the insulating face, provides a protection of the hub element against corrosion.

According to a characteristic of the invention, the insulating face comprises an elastomeric material.

According to a characteristic of the invention, the insulating face comprises an elastomeric material adhered to the face opposite the sliding face.

The insulating face of the sealing element comprises elastic properties allowing the insulating face to adhere to the hub element.

Thus, the seal between the insulating face and the hub element is improved.

According to a characteristic of the invention, the insulating face cooperates by a complementarity of shape with the hub element.

Thus the insulating face creates an element of protection against the corrosion phenomenon on the hub element.

According to a characteristic of the invention, the sliding face comprises a material insensitive to corrosion on which a lubricant is deposited.

The material can be for example a stainless steel, an aluminum, or a plastic.

Thus, the surface condition properties of the sliding face, that is to say in particular its low roughness, promotes the sliding of the bellows seal, and make it possible to ensure a seal with the bellows seal.

According to a characteristic of the invention, the sliding face is substantially flat.

According to a characteristic of the invention, an external edge of the sliding face comprises at least one retaining tab.

Thus, the retaining tab allows the sealing element to be clipped onto the bellows seal when assembling the assembly.

According to a characteristic of the invention, an external edge of the sliding face comprises a plurality of retaining tabs.

According to a characteristic of the invention, the sealing element has the general shape of a washer.

Thus the sealing element is intended to be positioned around a body of the steering ball joint.

According to a characteristic of the invention, the sealing element comes into contact with a body of the steering ball joint.

Thus, the seal element creates a perfect seal between the hub element and the bellows seal.

The invention also relates to a sealing element of a vehicle steering comprising an insulating face intended to be in contact with a hub element, a sliding face intended to be in contact with a bellows seal and at least one retaining tab extending over an outer edge of the sliding face.

The sealing element has the general shape of a washer comprising a central orifice intended to accommodate a body of a pivot of a steering ball joint. The insulating and sliding face have a substantially flat shape and comprise a material insensitive to corrosion (stainless steel, aluminum, plastic).

According to a characteristic of the invention, the insulating face comprises a plurality of ridges concentric with the central orifice making it possible, by elastic deformation of the ridges, to improve adhesion of the sealing element on the hub element.

The concentric ridges act as baffles.

The invention also relates to a method for mounting a steering assembly according to the invention, comprising:
A step of mounting a first end of the bellows seal on the steering ball joint,
A step of clipping the sealing element on a second end of the bellows seal,
A step of fixing the steering ball joint on the hub element so that the sealing element comes into contact with the hub element.

The steering ball joint comprises on the one hand a rotation casing in which is inserted a head of a pivot. The head of the pivot is extended by a body of a substantially cylindrical shape.

During the mounting step, the first end of the bellows seal is positioned around the body of the pivot and in contact with the rotation casing.

During the clipping step, the sealing element is fixed on the second end of the bellows seal. This step is facilitated by the presence of retaining tabs. This step can be performed before the mounting step or after the mounting step.

Finally, during the fixing step, the pivot body is inserted into the hub element. The pivot body and the hub element are retained by a nut screwed onto the pivot body. The nut is in contact with the hub element.

The invention will be better understood, thanks to the description below, which relates to an embodiment according to the present invention, given by way of non-limiting example and explained with reference to the accompanying schematic drawings, in which:

FIG. 1 is a view of an assembly according to the invention,

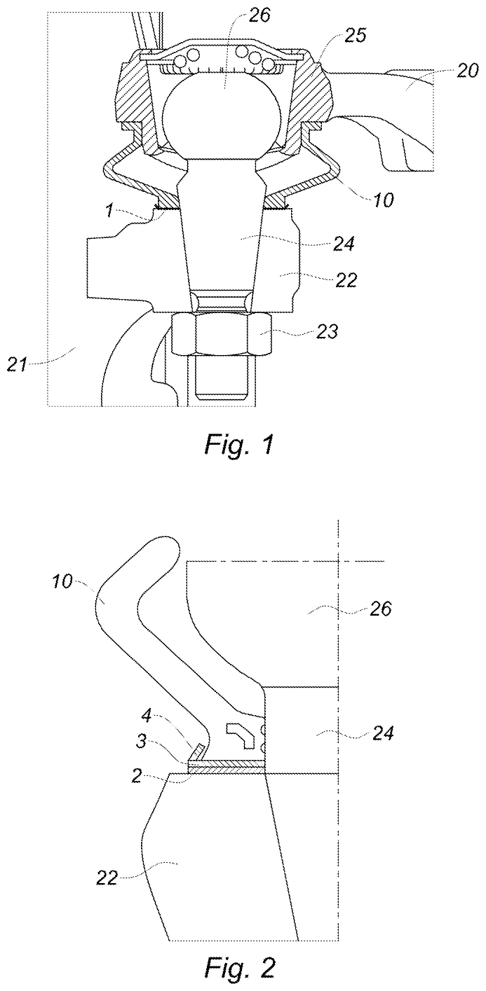

FIG. 2 is a sectional view of the assembly according to the invention,

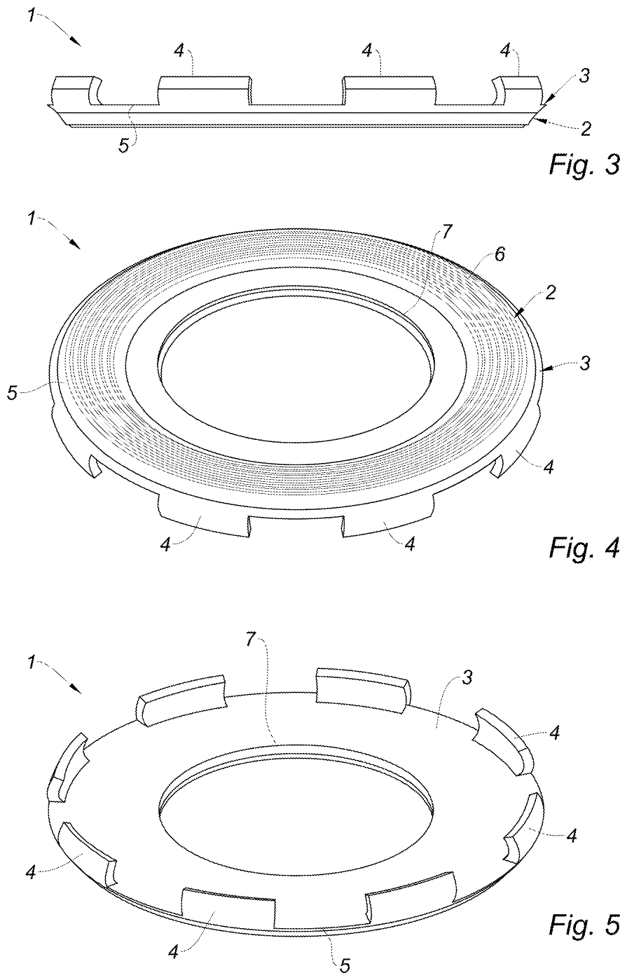

FIG. 3 is a lateral view of a sealing element according to the invention,

FIG. 4 is a bottom view of the sealing element,

FIG. 5 is a top view of the sealing element,

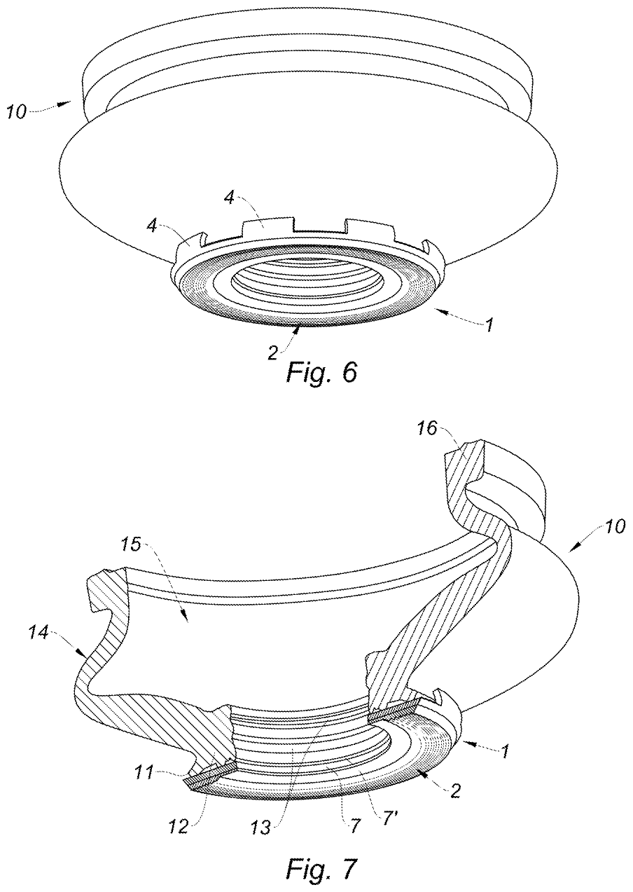

FIG. 6 is a perspective view of a bellows seal provided with a sealing element,

FIG. 7 is a perspective view with a truncated portion of the bellows seal provided with the sealing element.

FIGS. 3, 4 and 5 represent different views of a sealing element 1 according to the invention. The sealing element 1 has the general shape of a washer, that is to say that the sealing element 1 has a disc shape comprising a central through-orifice. The sealing element 1 thus comprises an internal edge 7, that is to say the edge formed by the through-orifice, or the edge having the smaller diameter and an external edge 5, that is to say the edge of the disc with the largest diameter. The sealing element 1 comprises materials insensitive to corrosion and it comprises in the plane in which the sealing element extends, a sliding face 3 and an insulating face 2.

The sliding face 3 has a substantially flat shape and extends from the internal edge 7 to the external edge 5. The sliding face is made of a material insensitive to corrosion, for example stainless steel, aluminum or plastic, having a low roughness. Furthermore, the external edge 5 of the sliding face 3 comprises a plurality of retaining tabs 4 made of the material insensitive to corrosion, for example stainless steel, aluminum or plastic. The retaining tabs 4 extend substantially perpendicular to the plane in which the sliding face 3 extends.

The insulating face 2 is made of an elastomeric material and has a substantially flat shape which extends from the internal edge 7 to the external edge 5. The insulating face 2 comprises a plurality of concentric ridges 6 acting as baffles and extending parallel to the internal edge 7.

FIGS. 6 and 7 represent a bellows seal 10 on which the sealing element 1 has been positioned.

The bellows seal 10 is a hollow solid of revolution made of an elastomeric material. It is determined that an interior portion 15 of the bellows seal 10 corresponds to a portion of the bellows 10 facing an axis of revolution and that an external portion 14 of the bellows is a portion opposite to the internal portion 15. Furthermore, the bellows seal 10 includes a first end 16 and a second end 12 having the general shape of a washer and extending in a plane perpendicular to the axis of revolution. The second end 12 of the bellows seal is extended on an external edge by a bulge 11. Finally, an internal portion of the bellows seal 10 close to the second end 12 includes recesses 13.

The sealing element 1 and more precisely the sliding face 3 is positioned on said second end 12 so that the retaining tabs 4 are positioned on the bulge 11. The internal edge 7 of the sealing element 1 and the internal edge 7′ of the second end 12 of the bellows seal 10 have a substantially identical dimension.

FIGS. 1 and 2 represent an assembly according to the invention. More specifically, FIG. 1 represents one end of a tie-rod 20 of a vehicle provided with a steering ball joint comprising a rotation casing 25 in which is inserted a pivot. The pivot comprises a head 26 of generally spherical shape positioned in the rotation casing 25, and a body 24 of a generally conical shape.

Furthermore FIG. 1 represents a vehicle wheel 21 provided with a hub element 22. The pivot body 24 is inserted into an orifice of the hub element 22.

In order to limit failures of the steering ball joint, such as a clearance or a noise, related to an introduction of dust and humidity between the rotation casing 25 and the head 26 of the pivot, the bellows seal 10 is positioned around the body 24 of the pivot so that the first end 16 is in contact with the rotation casing 25 and the sealing element 1 is placed between the second end 12 of the bellows seal 10 and the hub element 22. A nut 23 is screwed onto the body 24 of the pivot.

A method for mounting the steering assembly comprises a step of mounting a first end 16 of the bellows seal 10 on the steering ball joint. During this step, the first end 16 of the bellows seal 10 is positioned around the body 24 of the pivot and in contact with the rotation casing 25 so as to create a first sealed connection between the bellows seal 10 and the rotation casing 25.

The mounting method also comprises a step of clipping the sealing element 1 on a second end 12 of the bellows seal. The clipping step can be carried out upstream or downstream of the mounting step without modifying the invention. During the clipping step, the sealing element 1 is fixed on the second end 12 of the bellows seal 1. This step consists of introducing the bulge 11 between the retaining tabs 4 and the sliding face 3.

Next, the mounting method comprises a step of fixing the steering ball joint on the hub element so that the sealing element 1 comes into contact with the hub element 22. During the fixing step, the pivot body 24 is inserted into the orifice of the hub element 22. The pivot body 24 and the hub element 22 are retained by the nut 23. The nut 23 tightened against the hub element 22 so that the sealing element 1 comes, by an elastic deformation of the ridges 6, adhere to the hub element 22. A second tight connection is then created between the sealing element 1 and the hub element 22.

Moreover, the bellows seal 10 exerts a pressure on the sealing element 1, and more precisely on the sliding face 3, so that the second end 12 of the bellows seal is elastically deformed and creates a third tight connection between the bellows seal 10 and the sealing element 1. The possible addition of a lubricant on the sliding face 3 can reduce the friction during a rotational movement of the second end 12 relative to the sealing element 1 so that the third sealed connection is preserved.

Thus, the sealing element 1 and the bellows seal 10 are not degraded over time by a corrosion phenomenon.

Furthermore, the internal edge 7 of the sealing element 1 and the internal edge 7′ of the second end 12 of the bellows seal 10 contact the body 24 of the pivot so as to create a fourth sealed connection. Said fourth sealed connection is improved by the presence of a lubricating fluid in the recesses 13 of the bellows seal 10.

Thus the invention makes it possible to isolate the rotation casing 25 and the bellows seal 10 from the hub element 22 so that a degradation over time of the hub element 22 does not degrade the seal of the rotation casing 25 and the bellows seal 10.

Of course, the invention is not limited to the embodiments described and represented in the accompanying figures. Modifications remain possible, in particular from the point of view of the constitution of the various elements or by substitution of technical equivalents, without thereby departing from the scope of protection of the invention.

1. A steering assembly of a vehicle comprising a toe-rod whose one end comprises a steering ball joint, a hub element of a vehicle wheel, and a bellows seal positioned between the steering ball joint and the hub element, wherein the steering assembly further comprises at least one sealing element having an insulating face in contact with the hub element and a sliding face in contact with the bellows seal.

2. The steering assembly of a vehicle according to claim 1, wherein the sealing element comprises materials insensitive to corrosion.

3. The steering assembly of a vehicle according to claim 1, wherein the insulating face comprises an elastomeric material.

4. The steering assembly of a vehicle according to claim 1, wherein the insulating face cooperates by a complementarity of shape with the hub element.

5. The steering assembly of a vehicle according to claim 1, wherein the sliding face comprises a material insensitive to corrosion on which a lubricant is deposited.

6. The steering assembly of a vehicle according to claim 1, wherein the sliding face is substantially flat.

7. The steering assembly of a vehicle according to claim 1, wherein an outer edge of the sliding face comprises at least one retaining tab.

8. The steering assembly of a vehicle according to claim 1, wherein the sealing element has the general shape of a washer.

9. A sealing element of a vehicle steering comprising an insulating face intended to be in contact with a hub element, a sliding face intended to be in contact with a bellows seal and at least one retaining tab extending over an outer edge of the sliding face.

10. A method for mounting a steering assembly according to claim 1, comprising:
a step of mounting a first end of the bellows seal on the steering ball joint,
a step of clipping the sealing element on a second end of the bellows seal,
a step of fixing the steering ball joint on the hub element so that the sealing element comes into contact with the hub element.
